(19) United States
(12) Patent Application Publication
(10) Pub. No.: US 2012/0246673 A1
(43) Pub. Date: Sep. 27, 2012

(54) Apparatus for Insertion of Local Signals into a CATV Output

(76) Inventors: Sumit Kumar, Victoria (CA); Colin Howlett, Victoria (CA)

(21) Appl. No.: 13/366,695

(22) Filed: Feb. 6, 2012

Related U.S. Application Data
(60) Provisional application No. 61/454,630, filed on Mar. 21, 2011.

(51) Int. Cl. H04N 21/80

(52) U.S. Cl. 725/32

(57) ABSTRACT

Apparatus for switching and combining based on external signaling is provided wherein a locally generated modulated carrier (or carriers) is inserted into a CATV system between the cable head end and video decoding/rendering device without requiring unused channels or the loss of any incoming services. An RF switch is controlled by a switch control processor based on knowledge of the video decoding/rendering device current tuning requirements to select between the full spectrum coming from the CATV system the locally generated and inserted channel. Current tuning requirements for the attached video decoding/rendering device may be input to the switch control processor from the video decoding/rendering device itself or from a separate device with knowledge of the current service requirements.

This application claims the benefit under 35 USC 119(e) from Provisional Application 61/444,630 filed Mar. 21, 2011.

This invention relates to an apparatus for insertion of one or more locally generated modulated carriers into a CATV cable.

The invention can be applied to both QAM modulated signals and analog modulated signals such as NTSC, PAL etc.

### BACKGROUND OF THE INVENTION

There are several applications which commonly require insertion of locally generated modulated carriers into a CATV system where a set of existing modulated carriers already exists between the cable head-end and the video decoding/rendering devices (i.e. set-top box or cable-ready television tuner). These applications include, but are not limited to,

Closed-circuit TV or security cameras,

Customized channels for specific buildings such as hotels, hospitals or apartment buildings,

Insertion of audio-video signals from other sources within the home.

Existing insertion solutions are commonly done on a broadcast basis, where all video decoding/rendering devices are able to receive the inserted modulated carriers. In order to insert modulated carriers, there must either be:

Open channel(s) with no existing modulated carriers, where existing carriers can be simply combined into the existing,

OR

An added notch filter to remove any existing carriers which overlap in frequency before the local carriers can be combined with the input CATV carriers.

With modern CATV systems, operators want to maximize their spectrum usage by providing as many services as possible and carefully controlling the use of all carriers that can be carried over the CATV infrastructure. This implies that there are often no open channels. Since there are no open channels, any notch filter used will result in a loss of some subset of services to the end video decoding/rendering device. For this reason, notch filters need to be very narrow in band width, typically a single carrier. This type of notch filtering tends to be expensive and bulky.

### SUMMARY OF THE INVENTION

According to the present invention there is provided an apparatus for insertion of one or more locally generated modulated carriers into a CATV cable comprising:

an input port for receiving one or more broadcast CATV input modulated carriers;

a local generator, creating one or more carriers, each carrier being modulated with a QAM signal or analog video signal;

an output port for modulated carriers;

the CATV cable being arranged to communicate to a video decoding/rendering device which simultaneously tunes and demodulates one or more of the modulated carriers for supply to a display device associated with the video decoding/rendering device which displays video and/or audio content to a viewer;

and an arrangement obtaining knowledge of the state of the display device for combining the broadcast CATV input modulated carriers and the carriers of the local generator.

Preferably there is provided an RF switching/combining network associated with the input port and local generator which serves to direct signals from the input port or the local generator towards the output port.

Preferably there is provided a switch control processor associated with the RF switching network to control the behavior of the RE switching network.

Preferably there is provided a plurality of switch control input ports associated with the switch control processor and each switch control input port provides information regarding the carriers currently required for tuning by the video decoding/rendering device.

Preferably the information concerning the state of the display device comes directly from the video decoding/rendering device or from a separate device.

Preferably the apparatus allows the use for the local generator of any fixed QAM output frequency.

Preferably the frequency is decided in the design stage.

Preferably the frequency is in the range of the typical 50 MHz to 1 GHz downstream spectrum in CATV.

Preferably said arrangement uses the state of the display device to make a determination that allows it to “take over” the signal being fed to the display device and switch it back and forth between the full complement of signals coming in to the premise and the local signal.

Preferably the apparatus also acts to generate the local QAM as well.

In one embodiment the RF switching/combining network comprises a single RF switch to select either the full set of input modulated carriers or the full set of locally generated modulated carriers for output towards the video decoding/rendering device.

In another embodiment the RF switching/combining network comprises:

a plurality of filters associated with the input CATV signal;

each filter being an all-pass, low-pass, high-pass or band-pass filter;

a plurality of RF switches associated with the filters to select which filter (or no connection at all) is applied to the CATV input signal;

an RF switch associated with the local generator to select whether the locally generated modulated carrier(s) are passed to the RF multiplexer;

an RF multiplexer associated with the RF switches to combine the modulated carrier(s) coming from the input CATV signal and the local generator, with the modulated carriers output being determined by the RF switch settings.

Preferably the apparatus provides low-cost QAM.

Preferably the apparatus enables use of any QAM frequency without limiting access to the premise inbound CATV channels.

The arrangement as described herein provides a novel switching and RF combining techniques to achieve a very low cost for insertion of modulated carriers in a CATV system.

The arrangement as described herein allows insertion of locally generated signals in the on premises coaxial cable while retaining the full availability of signals present on the coaxial cable when it is inbound to the premises. It accomplishes this at a substantially lower cost and complexity then any prior solution by utilizing readily available knowledge of the state of the display device it is serving signals to and therefore opening up options to use low cost and simple methods to switch and/or combine between the signals present inbound to the premise and locally generated signals.

The arrangement as described herein will allow local insertion of a QAM signal at a cost much lower then any prior solution.

Typical QAM modulators are expensive because of the need to have agile frequency output covering the range of CATV downstream frequencies from 50 MHz to 1 GHz. The need to match the output frequency to an available “slot” in the channel plan creates the requirement for agility. Consequently, the cost of the QAM modulator is burdened by expensive, agile RF signal conversion implementations as well as digital calibration and compensation that must be added both in design, which increases development time and cost as well as BOM time and cost, and manufacturing, which increases manufacturing test time and cost and manufacturing test equipment cost. This is necessary in order to counteract the various RF influences that degrade the signal quality and noise spectra as the desired QAM channel is moved from one frequency output to another. The arrangement as described herein eliminates the need for an agile output frequency for the QAM served to the decoding/display device.

Further, the arrangement as described herein allows the use of any fixed QAM output frequency, which must be decided in the design stage, in the range of the typical 50 MHz to 1 GHz downstream spectrum in CATV. This is because the arrangement as described herein uses the state of the display device to make a determination that allows it to “take over” the signal being fed to the display device and switch it back and forth between the full complement of signals coming in to the premise and the local signal. The device could generate the local QAM as well. In fact, the low cost QAM generation itself is a part of the invention herein. Thus low-cost QAM is a part of the arrangement as described herein. The arrangement as described hereinafter is what enables low cost QAM.

Since the arrangement as described herein removes the need for frequency agility of the local QAM channel, this allows any fixed QAM output frequency to be used for the local QAM channel, it makes multiple low cost implementation methods for the generation of the local QAM channel readily feasible.

One embodiment provides a low-cost ASIC (application specific integrated circuit) or FPGA (Field programable gate array) which is used to generate the baseband digital QAM signal, the output of which is driven to a low-cost digital to analog converter that outputs the QAM channel directly between 50 and 100 MHz, frequencies which are now fully available for use since the arrangement as described herein enables use of any QAM frequency without limiting access to the premise inbound CATV channels whatsoever. This results in a substantially lower cost of local QAM insertion.

Another embodiment could be a low-cost ASIC or FPGA used to generate the baseband digital QAM signal, the output of which is driven to a low-cost RFIC that outputs the QAM channel directly between 700 to 900 MHz. Once again, these frequencies are fully available for use through the arrangement as described herein. Such RFICs are readily available in the marketplace at a low cost since they are used for cellular handset devices.

Finally, yet another embodiment could be the low cost ASIC/FPGA for digital QAM signal plus a DAC (digital to analogue converter) plus any low cost analog ASIC that performs signal conversion (IF to RF) to any fixed frequency within 50 MHz to 1 GHz. Alternatively, discrete signal conversion devices could be used instead of the analog ASIC.

The local signal that is inserted need not be limited to QAM or NTSC/PAL analog video signals. In fact any sort of digital or analog signal could be generated and inserted at low cost. Some examples that should be mentioned ultimately are other digital signals that the display device could utilize including OFDM (orthogonal frequency division multiplexing), security, command and control protocol signals, UPNP (Universal plug-n-play), IP modulated onto QAM, IP modulated onto OFDM, digital audio distribution in the home, etc, etc. Analog signals including audio, video, other could also be driven to the display device through the use of the arrangement as described herein. The key is that all of this can be accomplished because the arrangement as described herein enables the use of the coaxial cable within the premises at will to carry both the signals coming in to the premise from the outside world on the coaxial cable AND to carry any kind of signals generated within the premise. This is achieved very specifically by taking advantage of the knowledge of the state of the display device, something that is readily available today.

This arrangement as described herein therefore presents a method of low cost insertion of modulated carriers based on RF switching and/or combining, with RF switching controlled by knowledge of the output carriers required for tuning by an attached video decoding/rendering device.

A method of switching and combining based on external signaling is provided wherein a locally generated modulated carrier (or carriers) can be inserted into a CATV system between the cable head-end and video decoding/rendering device without requiring unused channels or the loss of any incoming services. An RF switch is controlled by a switch control processor based on knowledge of the video decoding/rendering device current tuning requirements to select between the full spectrum coming from the CATV system the locally generated and inserted channel. Current tuning requirements for the attached video decoding/rendering device may be input to the switch control processor from the video decoding/rendering device itself or from a separate device with knowledge of the current service requirements.

An alternative embodiment of the invention allows for simultaneous tuning to modulated carriers in both a subset of the incoming CATV signal path and/or the locally generated carrier(s) by adding additional RF switches in the input CATV signal path and an RF combiner. The additional RF switches in the input CATV signal path selects one of one or more filters to be applied to the incoming CATV signal path such that a subset of the CATV input carriers which does not overlap the locally generated modulated carriers can be passed to the output. The switches are controlled by the switch control processor based on knowledge of the current tuning requirements of the video decoding/rendering device. An RF combiner allows the filtered CATV input signals to be combined with locally generated carrier(s) that are needed for current tuning requirements.

### BRIEF DESCRIPTION OF THE DRAWINGS

FIG. 1 is a general block diagram of the insertion system showing the signals, functional entities and signaling between functional entities.

FIG. 2 is a diagram showing the RF switching implementation.

FIG. 3 is a diagram showing an alternative embodiment of the invention with support for simultaneous available of carriers from both a subset of the CATV input signals and the locally generated carriers.

### DETAILED DESCRIPTION

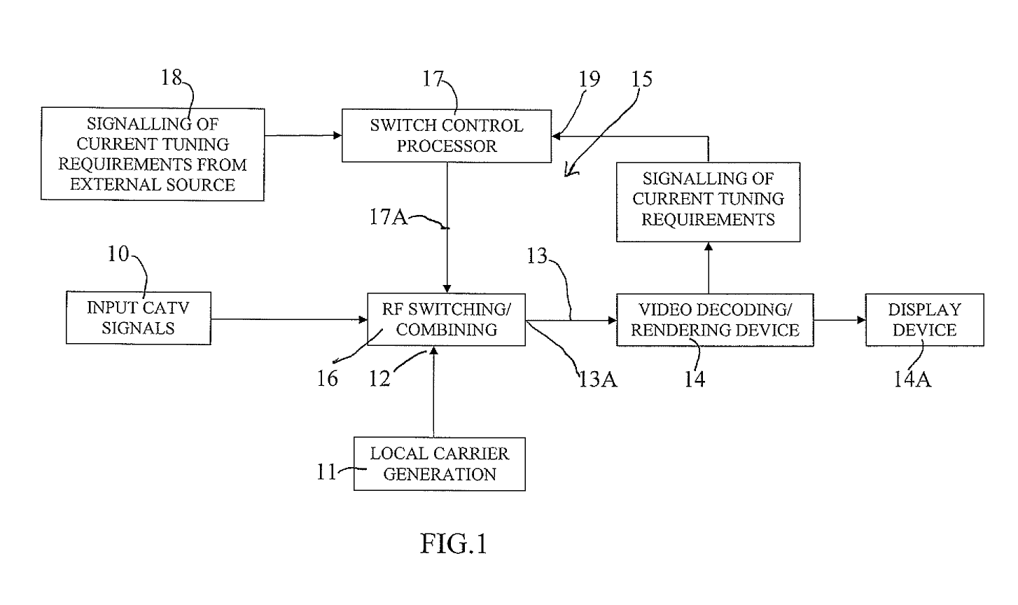

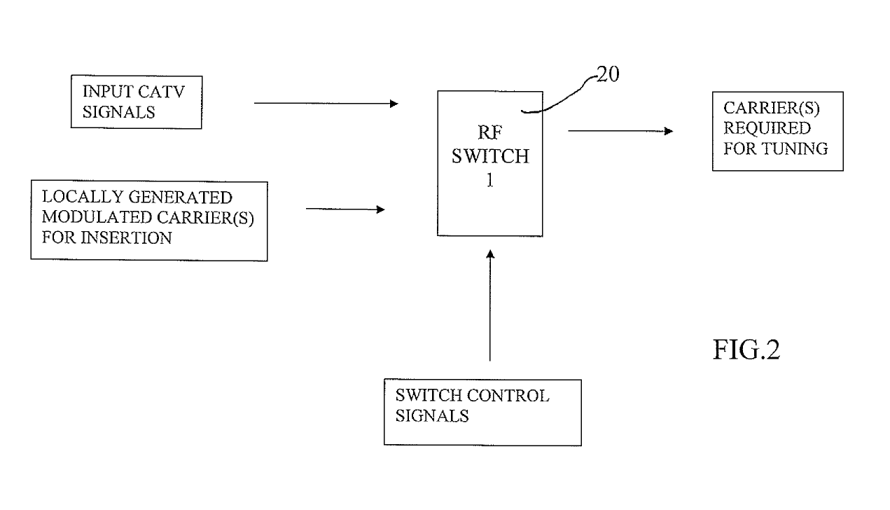

The apparatus shown in FIGS. 1 and 2 provides an arrangement for insertion of one or more locally generated modulated carriers into a CATV cable 13. This comprises an input port 10 for receiving one or more broadcast CATV input modulated carriers and a local generator 11, creating one or more carriers 12, each carrier being modulated with a QAM signal or analog video signal. An output port 13A of the cable 13 is provided for the modulated carriers required for tuning. The CATV cable is arranged to communicate to a video decoding/rendering device 14 which simultaneously tunes and demodulates one or more of the modulated carriers for supply to a display device 14A associated with the video decoding/rendering device which displays video and/or audio content to a viewer.

The CATV system including the video decoding device and the display are of course existing components not themselves part of the present invention.

There is in accordance with the present invention provided an arrangement 15 obtaining knowledge of the state of the display device for combining the broadcast CATV input modulated carriers and the carriers of the local generator.

Thus the arrangement 15 includes an RF switching/combining network 16 associated with the input port 10 and local generator 11 which serves to direct signals from the input port or the local generator towards the output port 13A.

Thus the arrangement 15 further includes a switch control processor 17 associated with the RF switching network to control the behavior of the RF switching network. This receives signals indicative of current tuning requirements either from the decoding device 14 or from an external source 18 and generates at 17A RF switch control signals.

Thus the arrangement 15 includes further a plurality of switch control input ports 18 and 19 associated with the switch control processor and each switch control input port provides information regarding the carriers currently required for tuning by the video decoding/rendering device.

That is the information concerning the state of the display device can come directly from the video decoding/rendering device or from a separate device.

The arrangement allows the use for the local generator of any fixed QAM output frequency in the range of the typical 50 MHz to 1 GHz downstream spectrum in CATV.

Thus the arrangement 15 uses the state of the display device to make a determination that allows it to “take over” the signal being fed to the display device and switch it back and forth between the full complement of signals coming in to the premise and the local signal. The apparatus by the device 11 also acts to generate the local QAM as well.

As shown in FIG. 2, the RF switching/combining network 16 comprises a single RF switch 20 to select either the full set of input modulated carriers or the full set of locally generated modulated carriers for output towards the video decoding/rendering device.

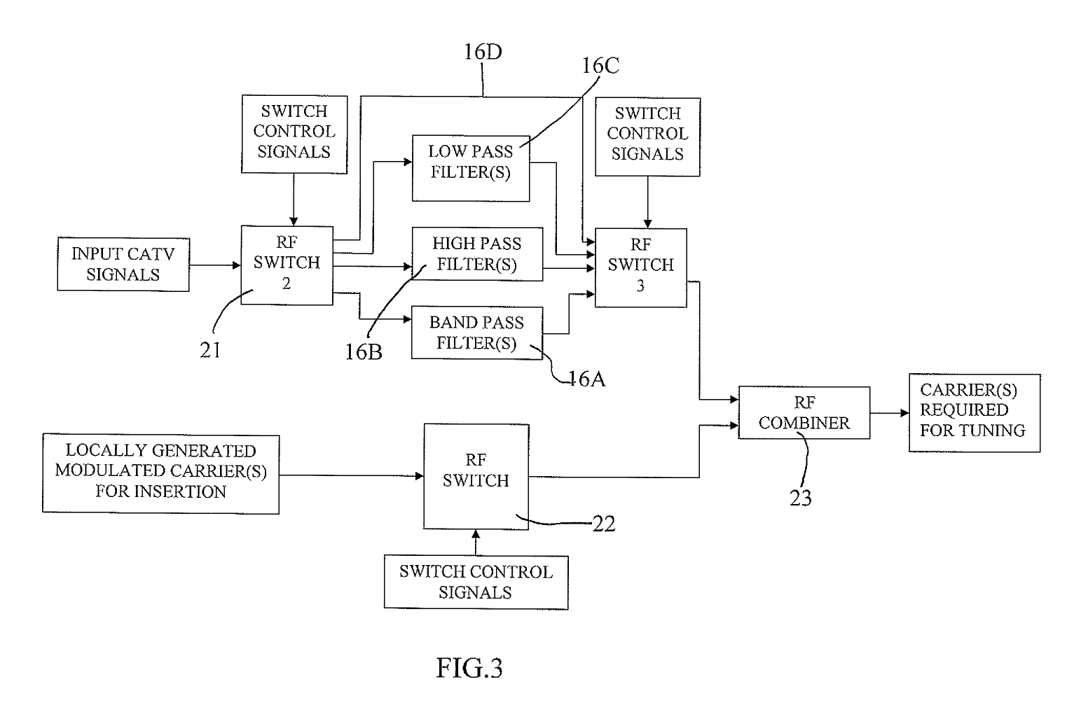

As shown in the alternative arrangement of FIG. 3, the RF switching/combining network 16 comprises a plurality of filters 16A, 16B and 16C each associated with the input CATV signal, each filter being an all-pass (path 16D), low-pass, high-pass or band-pass filter. The network 16 further includes a plurality of RF switches 21, 22 associated with the filters to select which filter (or no connection at all) is applied to the CATV input signal. An RF switch 22 is associated with the local generator to select whether the locally generated modulated carrier(s) are passed to the RF multiplexer 23.

The RF multiplexer 23 is associated with the RF switches to combine the modulated carriers coming from the input CATV signal and the local generator, with the modulated carriers output being determined by the RF switch settings.

1. An apparatus for insertion of one or more locally generated modulated carriers into a CATV cable comprising:
an input port for receiving one or more broadcast CATV input modulated carriers;
a local generator, creating one or more carriers, each carrier being modulated with a QAM signal or analog video signal;
an output port for modulated carriers;
the CATV cable being arranged to communicate to a video decoding/rendering device which simultaneously tunes and demodulates one or more of the modulated carriers for supply to a display device associated with the video decoding/rendering device which displays video and/or audio content to a viewer;
and an arrangement obtaining knowledge of the state of the display device for combining the broadcast CATV input modulated carriers and the carriers of the local generator.

2. The apparatus according to claim 1 wherein there is provided an RF switching/combining network associated with the input port and local generator which serves to direct signals from the input port or the local generator towards the output port.

3. The apparatus according to claim 2 wherein there is provided a switch control processor associated with the RF switching network to control the behavior of the RF switching network.

4. The apparatus according to claim 1 wherein there is provided a plurality of switch control input ports associated with the switch control processor and each switch control input port provides information regarding the carriers currently required for tuning by the video decoding/rendering device.

5. The apparatus according to claim 1 wherein the information concerning the state of the display device comes directly from the video decoding/rendering device or from a separate device.

6. The apparatus according to claim 1 which allows the use for the local generator of any fixed QAM output frequency.

7. The apparatus according to claim 6 wherein the frequency is decided in the design stage.

8. The apparatus according to claim 6 wherein the frequency is in the range of the typical 50 MHz to 1 GHz downstream spectrum in CATV.

9. The apparatus according to claim 1 wherein said arrangement uses the state of the display device to make a determination that allows it to “take over” the signal being fed to the display device and switch it back and forth between the full complement of signals coming in to the premise and the local signal.

10. The apparatus according to claim 1 wherein the apparatus also acts to generate the local QAM as well.

11. The apparatus according to claim 2 wherein the RF switching/combining network comprising a single RF switch to select either the full set of input modulated carriers or the full set of locally generated modulated carriers for output towards the video decoding/rendering device.

12. The apparatus according to claim 2 wherein RF switching/combining network comprises:
a plurality of filters associated with the input CATV signal;
each filter being an all-pass, low-pass, high-pass or band-pass filter;
a plurality of RF switches associated with the filters to select which filter (or no connection at all) is applied to the CATV input signal;
an RF switch associated with the local generator to select whether the locally generated modulated carrier(s) are passed to the RF multiplexer;
an RF multiplexer associated with the RF switches to combine the modulated carrier(s) coming from the input CATV signal and the local generator, with the modulated carriers output being determined by the RF switch settings.

13. The apparatus according to claim 1 wherein the apparatus provides low-cost QAM.

14. The apparatus according to claim 1 wherein the apparatus enables use of any QAM frequency without limiting access to the premise inbound CATV channels.
